(19) United States
(12) Patent Application Publication
(10) Pub. No.: US 2009/0201628 A1
(43) Pub. Date: Aug. 13, 2009

(54) MULTILAYER CERAMIC CAPACITOR AND METHOD OF MANUFACTURING THE SAME

(76) Inventors: Hiroshi Kagata, Osaka (JP); Satoshi Tomioka, Osaka (JP); Koichi Shigeno, Osaka (JP)

Correspondence Address: MCDERMOTT WILL & EMERY LLP, 600 13TH STREET, NW, WASHINGTON, DC, 20005-3096, US

(21) Appl. No.: 12/304,252

(22) PCT Filed: Mar. 14, 2008
(86) PCT No.: PCT/JP2008/000584

§ 371 Date: Dec. 10, 2008

(30) Foreign Application Priority Data
Mar. 15, 2007 (JP) 2007066119

(51) Int. Cl. H01G 4/12

(52) U.S. Cl. 361/321.4; 361/321.2; 29/25.42

(57) ABSTRACT

In a multilayer ceramic capacitor including: a laminated body layer formed by alternately laminating dielectric layers made of ceramic particles and internal electrodes; and a pair of external electrodes provided on at least both end surfaces of the laminated body layer and alternately connected to the internal electrodes electrically, the number of boundaries between ceramic particles per unit length of the dielectric layer in the lamination direction is larger than that in the direction connecting the pair of external electrodes. Thus increasing the number of ceramic grain boundaries between internal electrodes improves the insulation characteristic. Particularly, even if the number of ceramic particles thicknesswise decreases due to lamellation, increasing the number of grain boundaries suppresses deterioration of the insulation characteristic.

### TECHNICAL FIELD

The present invention relates to a multilayer ceramic capacitor used for various types of electronic appliances.

### BACKGROUND ART

A description is made for the structure of a conventional multilayer ceramic capacitor using FIGS. 5A, 5B.

FIG. 5A is a partial cutaway perspective view of a conventional multilayer ceramic capacitor. FIG. 5B is an enlarged sectional view of the substantial part of FIG. 5A. Dielectric layer 32 is formed mainly from barium titanate as ceramic particles 35, where laminated body 33 is formed with internal electrodes 31 and dielectric layers 32 alternately laminated. Laminated body 33 has a pair of external electrodes 34 formed on its both end surfaces, where internal electrodes 31 are alternately connected to the pair of external electrodes 34 electrically. In this way, ceramic capacitor 36 is formed.

In recent years, with thickness reduction of electronic appliances, a multilayer ceramic capacitor (multi-layer ceramic capacitor, referred to as MLCC hereinafter) as well has been demanded for thickness reduction. Means of reducing the thickness of an MLCC include lamellation of the dielectric layer. An example of such a technique is described in patent literature 1.

To lamellate a dielectric layer, ceramic particles has only to be made smaller. However, simply making ceramic particles smaller by lamellating the layer decreases the number of ceramic particles between internal electrodes, causing the insulation characteristic to deteriorate.

[Patent literature 1] Japanese Patent Unexamined Publication No. 2003-133164

### SUMMARY OF THE INVENTION

The present invention is a multilayer ceramic capacitor including a laminated body layer formed by alternately laminating dielectric layers made of ceramic particles and internal electrodes; and a pair of external electrodes provided at least on both end surfaces of the laminated body layer and alternately connected to the internal electrodes electrically, where the number of boundaries between ceramic particles per unit length of the dielectric layer in the lamination direction is larger than that in the direction connecting between a pair of external electrodes. Thus increasing the number of ceramic grain boundaries in the dielectric body between internal electrodes improves the insulation characteristic. Particularly, even if the number of ceramic particles thicknesswise decreases due to lamellation, increasing the number of grain boundaries suppresses deterioration of the insulation characteristic.

### BRIEF DESCRIPTION OF DRAWINGS

FIG. 1A is a partial cutaway perspective view of an MLCC according to an exemplary embodiment of the present invention.

FIG. 1B is an enlarged sectional view of part A in FIG. 1A.

FIG. 2 is an enlarged sectional view of FIG. 1B.

FIG. 3 is a step diagram showing the steps of producing barium titanate for an MLCC according to an exemplary embodiment of the present invention.

FIG. 4 is a step diagram showing the manufacturing steps of an MLCC according to an exemplary embodiment of the present invention.

FIG. 5A is a partial cutaway perspective view of a conventional MLCC.

FIG. 5B is an enlarged sectional view of the substantial part of FIG. 5A.

### REFERENCE MARKS IN THE DRAWINGS

1 Internal electrode
2 Dielectric layer
3 Laminated body
4 External electrode
5 Ceramic particles
6 MLCC (multilayer ceramic capacitor)
7 Constrained layer

### DETAILED DESCRIPTION OF PREFERRED EMBODIMENT

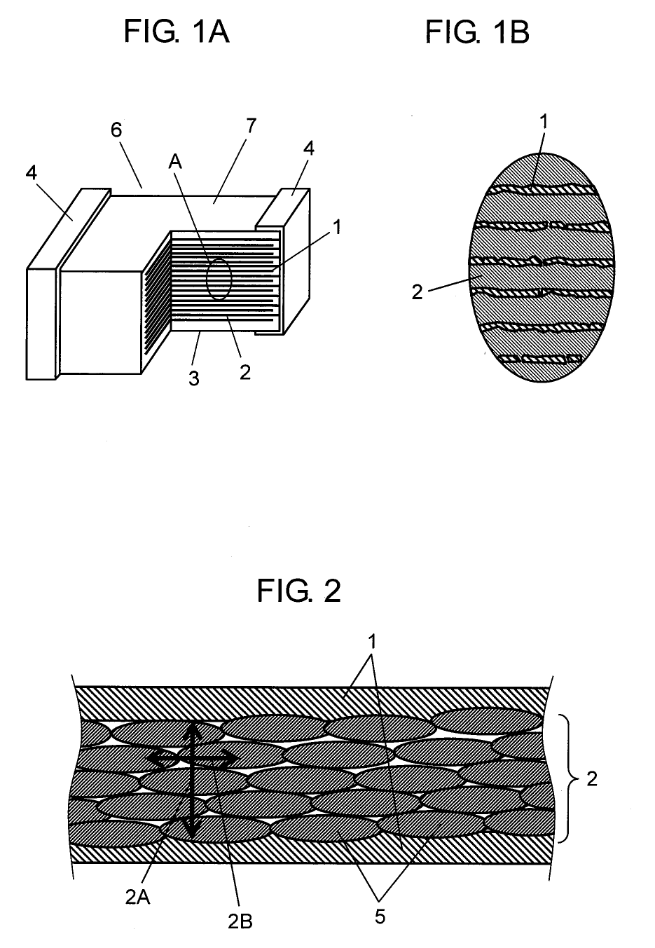

Hereinafter, a description is made for an example embodiment of the present invention using the related drawings. Here, the drawings are schematic and do not represent accurate dimensions of each position. The present invention is not limited to this exemplary embodiment. FIG. 1A is a partial cutaway perspective view of an MLCC according to an embodiment of the present invention. FIG. 1B is an enlarged sectional view of part A in FIG. 1A.

In FIG. 1A, laminated body 3 is formed by alternately laminating internal electrodes 1 and dielectric layers 2. Using one of nickel, copper, silver, palladium, and platinum as the principal component of the material of internal electrode 1 improves the high frequency property.

Dielectric layer 2 is mainly made of ceramic particles as its structure of a perovskite compound or tungsten bronze compound, for example. For a perovskite compound, the dielectric constant increases, where its principal component can be barium titanate.

For a tungsten bronze compound, meanwhile, the temperature characteristic is improved, where its representative materials include those based on Ba—Nd—Ti—O. To further improve the temperature characteristic, such as bismuth oxide can be added. Ceramic particles as a material of a tungsten bronze compound contain barium, rare earthes, and titanium.

One end surface of laminated body 3 has internal electrodes 1 exposed thereon at every other layer, and the other end surface has internal electrodes 1 exposed thereon that are not exposed on the aforementioned one end surface. Then, external electrodes 4 are respectively formed so as to electrically connect to internal electrodes 1 exposed on both end surfaces. MLCC 6 is thus structured.

A description is further made for dielectric layer 2 using FIG. 2. FIG. 2 is an enlarged sectional view of FIG. 1B, showing dielectric layer 2 between internal electrodes 1 is formed mainly from ceramic particles 5.

An MLCC according to an embodiment of the present invention features that the number of boundaries between ceramic particles 5 per unit length of dielectric layer 2 in the lamination direction (arrow 2A in FIG. 2) is substantively larger than that in the direction (arrow 2B in FIG. 2) connecting a pair of external electrodes 4. Usually, the thickness of dielectric layer 2 is approximately 0.5 μm to 20 μm. The number of the boundaries can be measured by the following method, for example.

That is, after making the grain boundaries observable by etching the fracture surface or polished surface of an MLCC, the surface is photographed with the aid of a scanning electron microscope. Next, straight lines with a certain length are drawn on the photo in the direction connecting a pair of external electrodes 4 and the lamination direction, and the numbers of grain boundaries crossing the straight lines are counted to calculate the numbers of boundaries between ceramic particles 5 per unit length. Although increasing measurement positions increases the accuracy in measuring the number of boundaries, an average value of approximately five measurement positions generally provides a sufficient accuracy.

“Boundary” in an MLCC according to an embodiment of the present invention refers to that formed by ceramic particles as the principal component, where a grain boundary phase formed by such as additives is included in a boundary.

Ceramic particles 5 used here has shape anisotropy, concretely such as acicular, plate-like, and columnar. With either of the shapes, as long as the relationship between the major axis and the minor axis holds (major axis/minor axis≧2), the minor axis direction of each ceramic particles is likely to point in the lamination direction when producing a ceramic green sheet (referred to as CGS hereinafter), thereby increasing the number of grain boundaries in the lamination direction.

In an MLCC (the case of FIG. 2) according to an embodiment of the present invention, assuming arrows 2A, 2B represent unit length, the number of boundaries of ceramic particles 5 in the direction (direction shown by arrow 2B in FIG. 2) connecting between a pair of external electrodes 4 is one; that in the lamination direction (direction shown by arrow 2A in FIG. 2) is four (i.e. four times), where making the number be at least three times or more further clarifies the advantages.

A method of producing shape-anisotropic barium titanate is that owing to hydrothermal reaction using a shape-anisotropic titanium compound as crystal nuclei, for example. The hydrothermal reaction is a method of generating crystals by exerting heat and pressure on a solution produced by dispersing a titanium compound and barium compound to promote the chemical reaction.

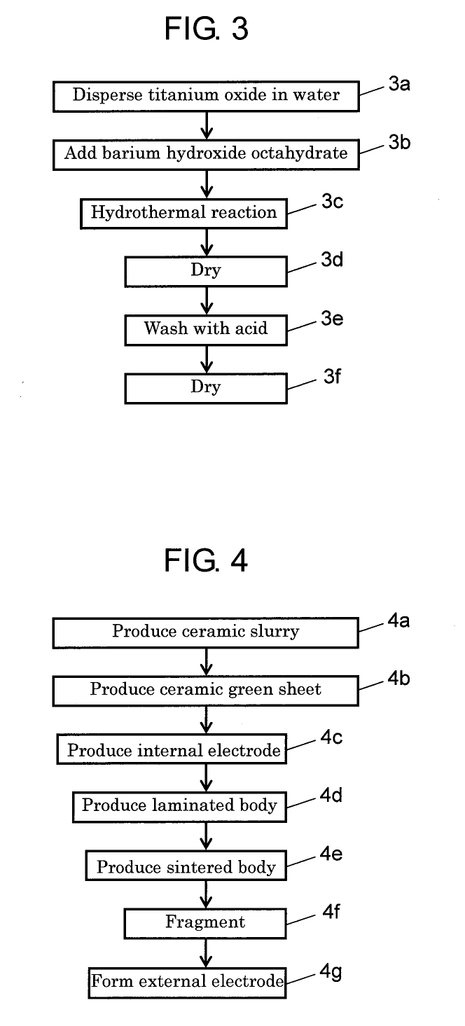

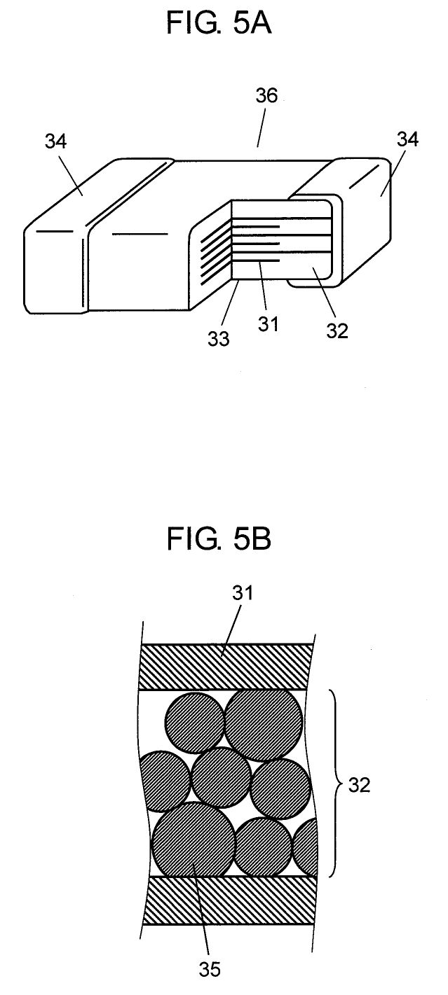

FIG. 3 is a step diagram showing the steps of producing barium titanate for an MLCC according to an embodiment of the present invention. First, titanium oxide as a shape-anisotropic titanium compound and water as a solvent are used to disperse the titanium oxide in the water (step 3a).

Next, barium hydroxide octahydrate as an alkali earth metal compound is added into the above-described aqueous solution of titanium oxide to produce a mixed solution (step 3b).

At this moment, barium is desirably contained more than titanium. That is, barium titanate as a final product has a perovskite structure, and the blend ratio of titanium oxide and barium salt is adjusted so that A/B>1.0 holds assuming the perovskite-type chemical formula is ABO₃ (A, B represent an element, O represents oxygen; here, element A is Ba, element B is Ti). Although barium titanate is likely to grain-grow if A/B≦1.0, arranging the blend ratio so as to hold A/B>1.0 suppresses grain growth at a hydrothermal reaction to be described later, facilitating generation of minute particles.

Here, a basic compound can be added to the aqueous solution of titanium oxide to increase the solubility of the alkali earth metal compound. Here, the basic compound is hydroxide such as sodium hydroxide and calcium hydroxide, or ammonia water, for example.

Adding a basic compound in this way shifts the aqueous solution of titanium oxide to alkali, thereby increasing the solubility of the alkali earth metal compound. In this way, increasing the concentration of the reactant in the mixed solution increases the reactivity in a hydrothermal reaction to be described later.

Next, the above-described mixed solution is put into a container for a hydrothermal reaction to cause a hydrothermal reaction at 200° C. (step 3c), where the temperature for a hydrothermal reaction is preferably 200° C. or higher. This is because a hydrothermal reaction at 200° C. or higher produces a product with higher crystallinity.

Next, the mixed solution that has completed its hydrothermal reaction is dried to yield barium titanate (step 3d). Next, this dried barium titanate is washed in an acid solution as required to remove remaining carbonate (step 3e). The carbonate is assumed to be generated by the reaction between a carbon dioxide gas dissolved in the solution and unreacted barium ions. Weak acid such as acetic acid is used as the acid solution. Removing impure substances remaining by washing in this way improves the reliability of an MLCC with this material used.

Next, the barium titanate washed in the acid solution is dried (step 3f) to produce desired barium titanate.

Here, a compound containing at least one of Mg, rare earthes, Mn, and Si may be added to the above-described mixed solution, which improves the temperature characteristic of the dielectric constant. The compound containing Mg, rare earthes, Mn, and/or Si may be added in any step as long as it is before a hydrothermal reaction. Rare-earth elements here include Y, Dy, Ho, and Er, for example.

Next, a description is made for a method of manufacturing MLCCs with shape-anisotropic ceramic particles used, of the present invention, using FIG. 4.

FIG. 4 is a step diagram showing the steps of manufacturing MLCCs according to an exemplary embodiment of the present invention.

First, ceramic slurry is produced by mixing ceramic particles primarily containing shape-anisotropic barium titanate, additives (e.g. MgO, MnO₂, SiO₂, Y₂O₃) for adjusting the electrical characteristics, polyvinyl butyral resin as a binder, and butyl acetate as a solvent and by dispersing them (step 4a).

Next, the slurry is applied on a film of polyethylene terephthalate (referred to as PET hereinafter) by a method such as doctor blading and dried to produce a CGS (step 4b).

At this moment, ceramic particles 5 has shape anisotropy, and thus the minor axis direction of the particles is likely to point in the lamination direction, thereby increasing the number of grain boundaries in the lamination direction.

Subsequently, a paste for internal electrodes, primarily containing metal nickel powder, composed of a binder, plasticizer, and solvent is produced by a publicly known method; a pattern for internal electrodes is applied on the PET film by screen printing; and dried to produce internal electrodes (step 4c). The dimensions, shape, and position of the pattern for internal electrodes are set so that fragmented MLCCs are obtained when cut and separated in the subsequent fragmentation step.

Then, a laminated body is produced by alternately laminating the above-described CGS and the above-described internal electrodes (step 4d).

Subsequently, after laminated body 3 is fired by a publicly known method to produce a sintered body (step 4e) and then fragmented (step 4f), external electrodes are formed so as to electrically connect to the internal electrodes exposed on both end surfaces of the sintered body fragmented (step 4g) to produce MLCC 6.

In the above-described firing step, the following method can be employ to further increase the number of grain boundaries in the lamination direction.

That is, the method is firing laminated body 3 while pressurizing it. By this method, grain growth of ceramic particles 5 in the CGS is likely to occur in the direction orthogonal to the pressurizing direction by pressurizing the laminated body when firing, thereby further increasing the number of grain boundaries in the lamination direction.

Meanwhile, there is another method. That is, laminated body 3 is fired with constrained layer 7 shown in FIG. 1A provided made of ceramic particles sintering at a temperature not lower than that at which dielectric layer 2 sinters, on the surface of the outermost layer of laminated body 3 in the lamination direction. Here, materials for constrained layer 7 include an insulating material made of one of alumina, magnesia, and zirconia when barium titanate is used for dielectric layer 2. Constrained layer 7 has only to have a sintering temperature different from that of dielectric layer 2.

Constrained layer 7 does not sinter at a temperature at which dielectric layer 2 sinters, and thus contraction is suppressed of the outermost layer of laminated body 3 due to sintering at firing in the direction orthogonal to the lamination direction. Meanwhile, nothing constrains contraction in the lamination direction, and thus contraction is likely to occur. Grain growth of ceramic particles 5 inside the CGS is likely to occur in the direction orthogonal to the lamination direction, thereby increasing the number of grain boundaries in the lamination direction.

Constrained layer 7 is removed after firing. At this moment, removing constrained layer 7 so that part of ceramic particles 5 contained in constrained layer 7 remains suppresses a solder flow.

In this case, the ceramic particles contained in constrained layer 7 preferably remain in an island-shaped manner so as to be dotted uniformly to the extent possible, where concretely such as blasting, polishing, or brushing is used. Thus, insulative particles can be formed (remain) on the surface of the outermost layer in the lamination direction on which external electrodes 4 are not formed.

There is another method in which internal electrode 1 is used instead of constrained layer 7. That is, the method uses the difference in sintering temperature between internal electrode 1 and dielectric layer 2. Particularly, making internal electrode 1 0.5 times or more thicker than dielectric layer 2 brings about the same effect as constrained layer 7 described above, where the upper limit of the thickness of internal electrode 1 is twice the thickness of dielectric layer 2 or less.

### INDUSTRIAL APPLICABILITY

A multilayer ceramic capacitor of the present invention is particularly useful for such as an electronic appliance requiring thickness reduction.

1. A multilayer ceramic capacitor comprising:
a laminated body formed by alternately laminating a dielectric layer made of ceramic particles and an internal electrode: and
a pair of external electrodes provided on at least both end surfaces of the laminated body and alternately connected to the internal electrode electrically,
wherein the number of boundaries between the ceramic particles per unit length of the dielectric layer in a lamination direction is larger than that in a direction connecting the pair of external electrodes.

2. The multilayer ceramic capacitor of claim 1, wherein a shape of each of the ceramic particles is acicular.

3. The multilayer ceramic capacitor of claim 2, wherein relationship between a major axis and a minor axis of the ceramic particle holds major axis/minor axis≧2.

4. The multilayer ceramic capacitor of claim 1, wherein a shape of each of the ceramic particles is plate-like.

5. The multilayer ceramic capacitor of claim 4, wherein relationship between a major axis and a minor axis of the ceramic particle holds major axis/minor axis≧2.

6. The multilayer ceramic capacitor of claim 1, wherein each of the ceramic particles is a perovskite compound.

7. The multilayer ceramic capacitor of claim 6, wherein the perovskite compound primarily contains barium titanate.

8. The multilayer ceramic capacitor of claim 1, wherein each of the ceramic particles is a tungsten bronze compound.

9. The multilayer ceramic capacitor of claim 8, wherein the ceramic particles contain barium, rare earthes, and titanium.

10. The multilayer ceramic capacitor of claim 1, wherein the internal electrode primarily contains one of nickel, copper, silver, palladium, and platinum as a material thereof.

11. The multilayer ceramic capacitor of claim 1, wherein the internal electrode is 0.5 times or more thicker than the dielectric layer.

12. The multilayer ceramic capacitor of claim 1, wherein ceramic particles made of a material with a sintering temperature different from that of the dielectric layer are formed at an surface of an outermost layer of the laminated body layer.

13. The multilayer ceramic capacitor of claim 12, wherein the insulative particles are made of one of alumina, magnesia, and zirconia.

14. A method of manufacturing a multilayer ceramic capacitor, the ceramic capacitor including:
a laminated body formed by alternately laminating a dielectric layer made of shape-anisotropic ceramic particles and an internal electrode: and
a pair of external electrodes provided on at least both end surfaces of the laminated body and alternately connected to the internal electrode electrically,
the method comprising:
firing the laminated body while pressurizing the laminated body in a lamination direction.

15. A method of manufacturing a multilayer ceramic capacitor, the ceramic capacitor including:
a laminated body formed by alternately laminating a dielectric layer made of shape-anisotropic ceramic particles and an internal electrode: and
a pair of external electrodes provided on at least both end surfaces of the laminated body and alternately connected to the internal electrode electrically,
the method comprising:
firing with a constrained layer made of the ceramic particles to be sintered at a temperature not lower than that at which the dielectric layer sinters, on a surface of an outermost layer of the laminated body in a lamination direction.

16. The method of manufacturing a multilayer ceramic capacitor of claim 15, wherein one of alumina, magnesia, and zirconia is used as the constrained layer.

17. The method of manufacturing a multilayer ceramic capacitor of claim 15, wherein the ceramic particles contained in the constrained layer are provided in an island-shaped manner after the firing.
